(19) United States
(12) Patent Application Publication
(10) Pub. No.: US 2004/0202444 A1
(43) Pub. Date: Oct. 14, 2004

(54) Multimedia data registering/offering method and system in vod system

(75) Inventors: Kyoung Soo Moon, Seoul (KR); Byung Dal Jung, Anyang-si (KR)

Correspondence Address: LEE, HONG, DEGERMAN, KANG & SCHMADEKA, P.C., 801 SOUTH FIQUEROA STREET, 14TH FLOOR, LOS ANGELES, CA, 90017, US

(73) Assignee: LG Electronics, Inc.

(21) Appl. No.: 10/117,891

(22) Filed: Apr. 8, 2002

(30) Foreign Application Priority Data
Jun. 14, 2001 (KR) 33420/2001

(51) Int. Cl. H04N 9/74

(52) U.S. Cl. 386/4

(57) ABSTRACT

Disclosed is a method and system of registering and providing multimedia data in a VOD system. The method registers multimedia data into at least two video servers, selects one having the smallest amount of current transmission load of the video servers, and connects the selected video server to a client at the request from the client so that the multimedia data is transmitted into the client and regenerated therein.

### BACKGROUND OF THE INVENTION

1. Field of the Invention

The present invention relates to a multimedia data registering/providing method and system in a Video on Demand (VOD) system. In particular, the method and system of the invention uses a main server for searching for the optimum one of video servers storing multimedia data so as to provide the multimedia data to a user at the request of the user.

2. Description of the Related Art

As well known to those skilled in the art, video servers and multimedia data transmission technologies have achieved remarkable development along with rapid progress in network technologies.

In particular, development of CODEC technologies of multimedia files allows a user to watch a multimedia file which is transmitted to his/her personal computer in real time through a network.

Transmission of multimedia data and the like utilizes a VOD system, which comprises a plurality of video servers storing duplications of the multimedia data so as to provide a stable service.

FIG. 1 shows a VOD system for serving multimedia data to a plurality of video servers in the related art.

Referring to FIG. 1 showing a conventional VOD system, any of clients 100 selects one video server, e.g. video server 100, 101 or 102, of a plurality of video servers 110 via a network in order to receive desired multimedia data. Then, the client is connected to a specific video server, and the multimedia data can be provided to the client 100.

However, when the clients 100 are crowded in one video server 100 of the plurality of video servers 110 which store the same multimedia data, respectively, resulting in overload of the video server 100, transmission rate of data drops to lower transmission efficiency.

In particular, if the same multimedia data are stored in a plurality of video servers, one video server which is readily accessible to the clients is crowded with requests from the clients so that transmission rates become insufficient.

Further, other servers which are hardly accessible to the clients are rarely used even though they have enough bandwidths.

### SUMMARY OF THE INVENTION

Accordingly the present invention has been made to solve the foregoing problems and it is an object of the invention to provide a method and system for registering/providing multimedia data with a VOD system which designates a unique identifier to multimedia data inputted from an operator of a main server, stores the multimedia data into the main server, retrieves video servers storing the multimedia data with index information associated with the identifier at the request of multimedia data transmission and regeneration from a client, and connects an adequate one having the smallest amount of load of the retrieved video servers to the client.

To achieve the above object, there is provided a method of registering and providing multimedia data in a VOD system, the method comprising the following steps of inputting multimedia data subject to service and index information of the multimedia data into a main server, the multimedia data being stored into at least two video servers; designating a unique identifier to the multimedia data; and storing position information of the video servers storing the multimedia data, the index information of the multimedia data and the unique identifier into a general information management database.

In addition, the present invention provides a system of registering and providing multimedia data in a VOD system includes at least one client; at least two video servers; a network with one end connected to said client; and a main server connected to the other end of said network and to said video servers for inspecting load of said video servers, wherein said main server selects the optimum video server to be connected to said client at the request of multimedia data transmission from said client.

### BRIEF DESCRIPTION OF THE DRAWINGS

The above and other objects, features and other advantages of the present invention will be more clearly understood from the following detailed description taken in conjunction with the accompanying drawings:

FIG. 1 shows a VOD system for providing a service with a plurality of video servers in the related art;

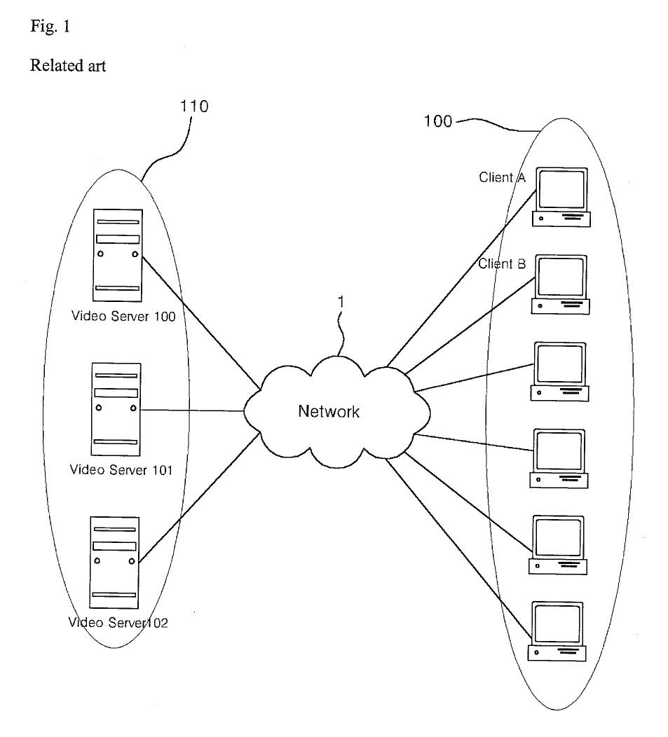

FIG. 2 shows a VOD system according to an embodiment of the invention;

FIG. 3 is a flow chart illustrating a process of registering multimedia data through a VOD system according to an embodiment of the invention; and

FIG. 4 is a flow chart illustrating a process of providing a client with multimedia data through a VOD system according to an embodiment of the invention.

### DETAILED DESCRIPTION OF THE PREFERRED EMBODIMENT

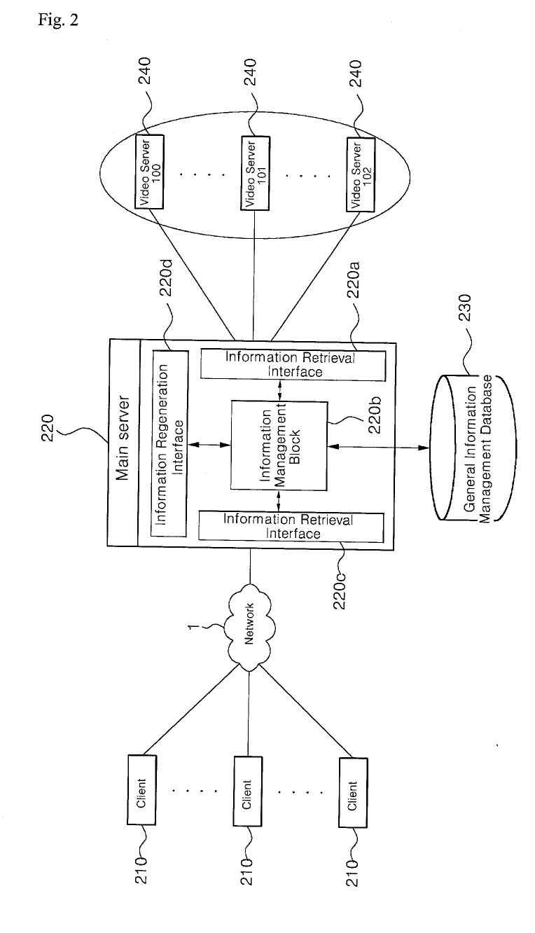

The following detailed description will present a preferred embodiment of the invention in reference to FIGS. 2 to 4.

As shown in FIG. 2, a VOD system of the invention comprises a network 1, a plurality of clients 210 connected to one end of the network 1, a main server 220 connected to the other end of the network 1, a general information management database 220 storing information of the main server 220, and video servers 240.

The VOD system according to the embodiment of the invention will be described in more detail as follows.

The general information management database 230 at least stores index information of multimedia data so as to allow retrieval for the multimedia data at the retrieval request from the clients 210. To be specific, the general information management database 230 stores position information of the multimedia data in addition to the index information. The index information is allocated with an identifier proper to the multimedia data, and the index information and the position information of the multimedia data corresponding thereto are stored in a conjunctive manner into the general information management database 230.

In the meantime, the position information contains serial numbers of the video servers 240 for storing the multimedia data and file passage information for indicating positions where the multimedia data are stored in the video servers 240.

Further, the general information management database 230 can be embodied inside the main server with small capacity.

Although the network 1 is shown and described as a unitary communication network to which the clients are connected, the network 1 is not limited thereto but can be embodied as a wire or radio communication network or a variety of communication networks which are overlapped at least in part according to another embodiment of the invention.

The structure and operation of the main server 220 will be described in more detail as follows.

The main server 220 is divided into a number of blocks performing their own specific functions so as to more efficiently process information and messages which are managed in the system of the invention. To be more specific, the main server 220 includes an information registration interface 220a, an information management block 220b, an information retrieval interface 220c and an information regeneration interface 220d.

The information registration interface 220a is an interface for receiving multimedia data which will be served to the clients 210 from an operator. At inputting the multimedia data, the operator of the main server inputs the multimedia data as a whole including the index information such as classification, producer, title, subject and explanation.

Further, the information registration interface 220a so functions that a variety of multimedia data inputted by the operator are duplicated into at least two video servers.

The information management block 220b designates a unique identifier to the multimedia data and their index information transmitted from the information registration interface 220a. Further, the information management block 220b receives the file passage information of the plurality of multimedia data, i.e. the position information of the plurality of multimedia data stored in the video servers 240, and adds the same unique identifier which are designated to the index information to the multimedia data stored in the video servers by referring to the received position information.

The information retrieval interface 220c is an interface used for retrieval of the multimedia data requested from the clients. Describing the operation of the information retrieval interface 220c, upon receiving the index information from one of the clients which wants a multimedia data service, the information retrieval interface 220c drives a retrieval engine to obtain the multimedia data matching the index information by retrieving the general information management database 230.

Further, the information regeneration interface 220d is an interface for carrying out transmission of the multimedia data at the request of transmission and regeneration from the one client when it is confirmed that the multimedia data are recorded in the video servers 240. Describing the operation of the information data interface 220d, upon receiving a regeneration request message transmitted from the one client 210, the information data interface 220d retrieves the video servers 240 storing the multimedia data in the general information management database 230.

The video servers 240 are provided in plurality, and designated with serial numbers, respectively. The video servers 240 duplicate and store the multimedia data inputted via the information registration interface 220a, and the extracted file passage information of the multimedia data is transmitted into the information management block 220b.

It will be briefly described about a process of providing the multimedia data according to the embodiment as follows.

The one client 210 can receive its own desired multimedia data which are transmitted from the main server 220 via the network 1. Further, the client 210 transmits proper index information for searching for the desired multimedia data into the main server 220.

Further, upon receiving the index information from the client 210, the main server 220 can discriminate the video servers 240 storing the multimedia data requested from the client 210 by matching the index information of the multimedia data provided from the client 210 to the index information stored in the general information database 230. In this case, the corresponding position information utilizes information which is inputted in a registration step of the multimedia data.

In the meantime, at least two of the video servers 240 are preferably provided for storing the identical multimedia data.

Upon discriminating positions of the video servers 240 storing the requested multimedia data, a specific video server 240 is selected.

To be more specific, a specific video server 240 having the smallest amount of load is selected by comparing the degrees of load of the video servers 240 to one another so that the client 210 can be efficiently provided with the multimedia data.

The client 210 can receive and regenerate the desired multimedia data from a more suitable video server 240 through execution of the above presented process.

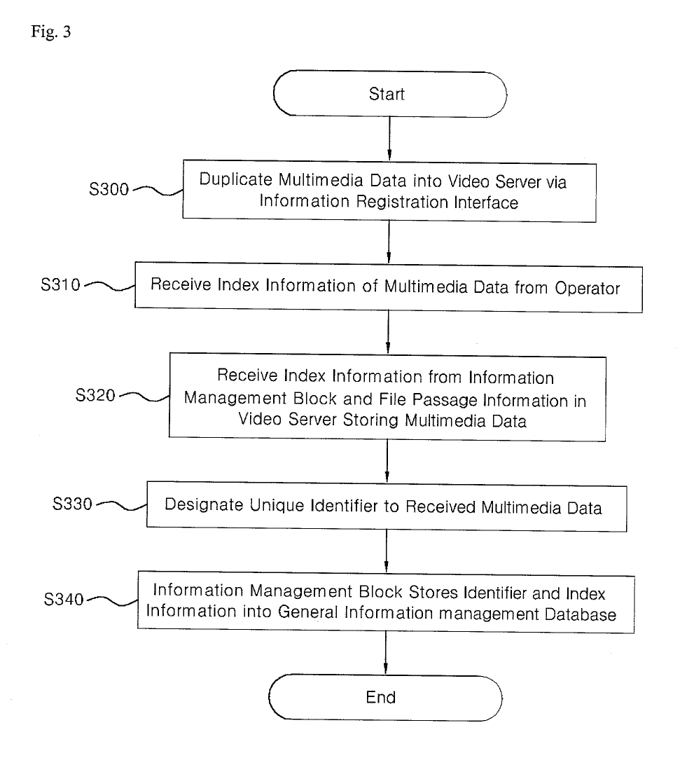

FIG. 3 is a flow chart illustrating a process of registering multimedia data through the VOD system according to the embodiment of the invention.

A process of multimedia data registration in the VOD system of the invention will be described in reference to FIG. 3.

Certain multimedia data are inputted via the information registration interface 220a from the operator, and duplicated and stored into at least two video servers 240 under the control of the information management block 220b in s300.

Further, the information registration interface 220a receives data information of the multimedia data from the operator together with index information corresponding to the inputted multimedia data in s310.

Exchanging the sequences of the s300 step of inputting/storing the multimedia data and the s310 step of inputting the index information of the multimedia data does not make any difference in the effect of the embodiment.

In the meantime, the information management block 220b receives the index information of the multimedia data from the information registration interface 220a. Further, the information management block 220b receives the file passage information in the at least one video server 240 storing the multimedia data from the video server 240 s320.

Further, the information management block 220b designates a unique identifier to each of the multimedia data in s330.

Further, after the unique identifier is designated in the s330 step of designating a unique identifier, the information management block 220b stores the unique identifier and the index information into the general information management database 230 in s340.

The above described process will be summarized in brief as follows. After designating the unique identifier corresponding to the each multimedia data inputted by the operator and inputting the index information, the one client represents only the index information corresponding to the each multimedia data so that the corresponding unique identifier is recognized and the multimedia data are retrieved and transmitted by using the unique identifier.

In other words, upon recognition of the unique identifier corresponding to the multimedia data requested by the client, signal transmission is executed between the main server 220 (FIG. 2) and the video server 240 (FIG. 2) via the unique identifier. Further, a tracking process of the main server 220 for the position of the multimedia data can be obtained via the position information inputted via the information registration interface 220a.

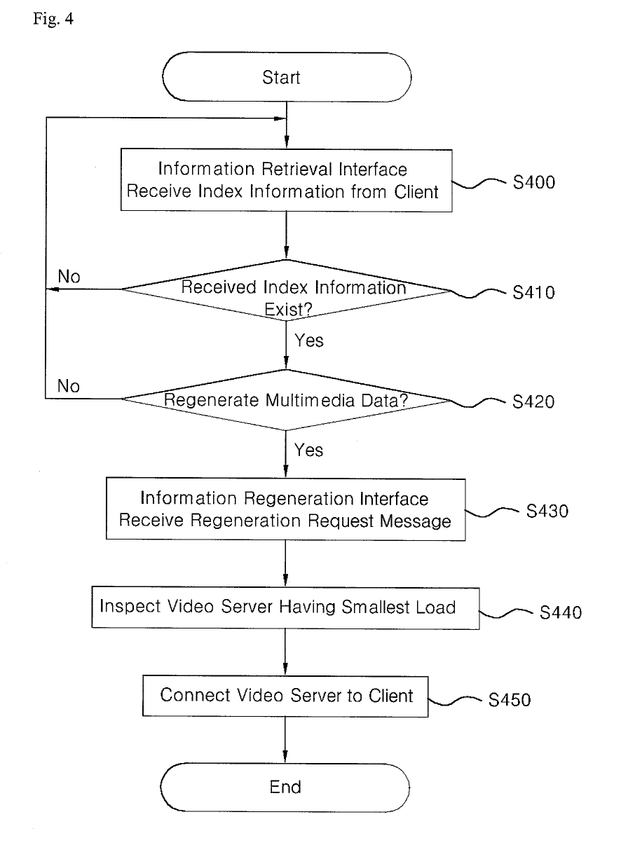

FIG. 4 is a flow chart illustrating a process of providing a client with multimedia data through the VOD system according to the embodiment of the invention.

The process of providing the multimedia data to the client will be described in reference to FIG. 4 as follows.

The information retrieval interface 220c (FIG. 2) receives certain index information from one client 210 connected via the network 1 in s400. The index information can be used at least selectively for discrimination of the multimedia data desired by the client 210.

The information retrieval interface 220c executes a retrieval engine to retrieve whether the general information management database 230 has index information matching the index information from the client 210 in s410.

In the s410 step of retrieving the multimedia data, if the index information identical to that from the client 210 exists in the general information management database 230, the client 210 judges whether to regenerate the desired multimedia data in s420. If the multimedia data desired by the client 210 does not exist, the main server 220 (FIG. 2) transmits a message informing non-existence thereof and then stands by for input of index information corresponding to another multimedia data.

In the s420 step of judging regeneration of the multimedia data, if the client 210 wants to regenerate the multimedia data, a regeneration request message transmitted by the client 210 is received to the information regeneration interface 220d (FIG. 2) in s430.

The information regeneration interface 220d finds out the position information of the at least one video server 240 storing the multimedia data based upon the index information by using the general information management database 230. In particular, the information regeneration interface 220d inspects the video server having the smallest amount of load from the at least two video servers 240 (FIG. 2) which are grasped as storing the multimedia data, and selects the video server 240 having the smallest amount of load to provide the multimedia data to the client in s440.

To be more specific, in the s440 step of retrieval and selection, the specific video server 240 having the smallest amount of load is selected. However, the invention may have various references for selecting a suitable video server such as the difference of prices which the client pays according to retrieval and use of the video server 240, the difference of network conditions and the difference of service qualities of the video server 240.

To be more specific, a server having a smaller amount of load may be selected as the client pays more. A specific video server 240 adequate to the transmission speed of the network 1 (FIG. 2) may be selected. Further, a video server 240 having a larger amount of load may be preferably selected rather than those having a lower amount of load, if the video server 240 has a superior quality and thus can transmit data more efficiently even under the larger amount of load.

The information regeneration interface 220d allows the client 210 to be connected to the selected video server 240 so that the client 210 can regenerate the desired multimedia data transmitted from the video server 240 in s450.

According to the method of equalizing the server in the VOD video system of the invention as set forth above, the main server retrieves the optimum video server having the smallest amount of load to provide the multimedia data so that the client can be more stably provided with the desired multimedia data.

Further, there is an advantage that the client can be transmitted with the desired multimedia data more rapidly.

What is claimed is:

1. A method of registering and providing multimedia data in a VOD system, the method comprising the following steps of:
(a) inputting multimedia data subject to service and index information of the multimedia data into a main server, the multimedia data being stored into at least two video servers;
(b) designating a unique identifier to the multimedia data; and
(c) storing position information of the video servers storing the multimedia data, the index information of the multimedia data and the unique identifier into a general information management database.

2. The method of registering and providing multimedia data in a VOD system according to claim 1, wherein the unique identifier is identically designated to all of the multimedia data and the position information and index information of the multimedia data.

3. The method of registering and providing multimedia data in a VOD system according to claim 1, wherein the index information includes at least the classification of the multimedia data.

4. The method of registering and providing multimedia data in a VOD system according to claim 1, wherein the index information includes at least the title of the multimedia data.

5. The method of registering and providing multimedia data in a VOD system according to claim 1, wherein the index information includes at least the producer of the multimedia data.

6. The method of registering and providing multimedia data in a VOD system according to claim 1, wherein the index information includes at least the index word of the multimedia data.

7. The method of registering and providing multimedia data in a VOD system according to claim 1, further comprising the step of: extracting the position information of the multimedia data stored in the video servers after said (a) step of inputting the multimedia data and the index information.

8. A method of registering and providing multimedia data in a VOD system, the method comprising the following steps of:
(a) connecting to a main server via a network, and inputting index information for retrieval of multimedia data requested from a client;
(b) discriminating the desired multimedia data according to the index information inputted from the client and retrieving a general information management database, by the main server, to transmit a retrieval result into the client;
(c) if the desired multimedia data are stored, transmitting a regeneration request message into the main server;
(d) retrieving, by the main server upon receiving the regeneration request message, at least one video server storing the multimedia data requested from the client into the general information database; and
(e) confirming load of at least two retrieved video servers, and selecting the optimum video server and connecting the same to the client for transmitting the multimedia data.

9. The method of registering and providing multimedia data in a VOD system according to claim 8, wherein said (e) step selects a video server having the smallest amount of load.

10. The method of registering and providing multimedia data in a VOD system according to claim 8, wherein said (e) step selects a video server having a condition most adequate to the network to which the client is connected.

11. The method of registering and providing multimedia data in a VOD system according to claim 8, wherein said (e) step selects a video server satisfying the best service quality according to specifications of the video server.

12. A method of registering and providing multimedia data in a VOD system, the method comprising the following steps of:
registering multimedia data into at least two video servers; and
selecting one having the smallest amount of current transmission load of the video servers and connecting the selected video server to a client at the request from the client, whereby the multimedia data is transmitted into the client and regenerated therein.

13. A system of registering and providing multimedia data in a VOD system comprising:
at least one client;
at least two video servers;
a network with one end connected to said client; and
a main server connected to the other end of said network and to said video servers for inspecting load of said video servers, wherein said main server selects the optimum video server to be connected to said client at the request of multimedia data transmission from said client.

14. The system of registering and providing multimedia data in a VOD system according to claim 13, further comprising a general information management database connected to said main server for storing at least one of position information of the multimedia data, a unique identifier of the multimedia data and index information of the multimedia information.

15. The system of registering and providing multimedia data in a VOD system according to claim 13, wherein said main server comprises:
an information registration interface for storing the multimedia data into said video servers by an operator of said main server;
an information retrieval interface for assisting retrieval of the multimedia data at the request from said client;
an information regeneration interface for connecting said optimum video server to said client; and
an information management block connected to at least one of said information registration interface, said information retrieval interface and said information regeneration interface for storing and generating information.
